(19) United States
(12) Patent Application Publication
(10) Pub. No.: US 2016/0168741 A1
(43) Pub. Date: Jun. 16, 2016

(54) CONTACT ELEMENT WITH GOLD COATING

(71) Applicant: HARTING KGAA, Espelkamp (DE)

(72) Inventors: Alexander Meyerovich, Espelkamp (DE); Frank Brode, Berlin (DE)

(21) Appl. No.: 14/904,926

(22) PCT Filed: Jul. 4, 2014
(86) PCT No.: PCT/DE2014/100229

§ 371 Date: Jan. 13, 2016

(30) Foreign Application Priority Data
Aug. 29, 2013 (DE) 10 2013 109 400.7

(51) Int. Cl. C25D 5/12; C25D 5/34; C25D 5/36; C25D 7/00; H01B 13/00; B32B 15/01; H01B 1/02; C25D 5/18; C25D 3/62; C25D 5/10; C25F 1/00

(52) U.S. Cl. CPC C25D 5/12; C25D 5/10; C25D 5/34; C25D 5/36; C25D 7/00; C25F 1/00; B32B 15/013; B32B 15/018; H01B 1/02; H01B 1/026; C25D 5/18; C25D 3/62; H01B 13/00

(57) ABSTRACT

The invention relates to a method for producing an electric contact element, the base of the contact element being made of a metal substrate which undergoes the following method steps in the listed order: a. a cold and/or hot and/or electrolytic degreasing of the substrate, b. an activation of the surface of the substrate i. in a nickel strike bath or ii. in a fluoride-containing activation solution or iii. in a fluoride-free activation solution, c. a galvanic deposition of an intermediate layer i., wherein a galvanically deposited nickel layer or ii. a nickel alloy layer, or iii. a copper alloy layer is applied as the intermediate layer, and d. an electrolytic deposition of a gold alloy layer in a direct and/or pulse current method in which the current density ranges from 0.3 to 0.6 A/dm².

The invention relates to a method for producing an electrical contact element as claimed in claim 1 and to a contact element as claimed in claim 6 which is produced by said method.

Contact elements of this type are often used in insulating elements of plug-in connectors. An electrical conductor is electrically connected to the contact element, for example by what is termed the crimping technique.

Contact elements may be configured in the form of pin contacts or socket contacts. The plug-in connectors equipped with such contact elements are often used in the automotive industry and are therefore placed under a particular cost pressure.

### PRIOR ART

Since cadmium-containing salts and solutions are classed as harmful to health and hazardous and in part also as poisonous, these coatings have for many years been classed as not being RoHS-compliant.

If the gold alloy baths which are used in coating methods are cadmium-free, the hardness and the abrasion resistance of the top layer produced are generally lower.

The base material of a contact element often consists of non-ferrous metal alloys. Non-ferrous metal alloys are, for example, copper or a copper alloy or steel.

In the case of galvanic coating methods, the base material is also referred to as the substrate. The substrate is often covered by galvanic layers comprising gold, silver and alloys, such as for example gold-cobalt or gold-nickel with less than 1.0%, commonly less than 0.5%, of the alloying elements. Although these layers used in the prior art have the required electrical conductivity, they have the disadvantage that they are very soft and are abraded rapidly.

EP 1 260 609 A1, US 2005/0196634 A1 and U.S. Pat. No. 5 858 557 A each disclose substrates covered with a gold or gold alloy layer. The methods proposed therein for producing such a gold or gold alloy layer are either too expensive or produce layers with an excessively low abrasion resistance.

### OBJECT

It is an object of the invention to propose a method for producing an electrical contact element which is cost-effective and environmentally friendly and nevertheless provides a contact element which is mechanically and thermally stable and moreover has good abrasion resistance given high plug cycles.

The object is achieved by the characterizing features of claim 1.

Advantageous embodiments of the invention are stated in the dependent claims.

The base or else the base material of the contact element according to the invention is formed by a metallic substrate.

The metallic substrate is advantageously copper or a copper alloy or steel. These materials have proved to be particularly suitable for the following method.

The substrate is firstly degreased. The degreasing can be effected by a cold and/or hot and/or electrolytic process (method step a).

Then, the degreased surface of the substrate is activated (method step b). The activation can be effected optionally in a nickel strike bath, in a fluoride-containing activation solution or in a fluoride-free activation solution (method steps bi, bii, biii).

In the following working step, an intermediate layer is galvanically deposited on the activated surface (method step c). This is preferably a nickel layer, a nickel alloy layer or a copper alloy layer (method steps ci, cii, ciii).

A gold alloy layer can then be electrolytically deposited on the intermediate layer (method step d).

The main advantage of the method consists in the fact that the hard gold alloy according to the invention is very hard, thermally stable and inhibits adhesion. It moreover exhibits a very good wear behavior, i.e. low abrasion values, and at the same time a favorable friction behavior, i.e. low coefficients of friction, and this leads to low plug forces.

The coating properties of contact elements, such as for example the abrasion resistance (service life loading), were assessed by what is termed a plug cycle test with the contact resistance measurements in accordance with standards DIN-EN-60512-9-3 and DIN-EN-60603-2.

It has surprisingly been found not only that the coating according to the invention satisfies the demands in respect of the electrical and mechanical properties of the contact elements, but also that the service life of the contacts is increased compared to comparable, commercially available contact elements on account of an increased abrasion resistance.

Compared to low-alloyed gold-cobalt or gold-nickel coatings, the coatings according to the invention have a relatively high hardness. The hardness is between 250 and 450 HV, but preferably between 300 and 400 HV. HV denotes a hardness value in accordance with the known Vickers hardness test.

The coating proposed here can preferably be deposited easily and cost-effectively by galvanic deposition and in particular by means of a continuous current or pulsed current method. A current density of between 0.3 and 0.6 A/dm² has proved to be particularly advantageous here.

The gold alloy layer is preferably deposited from an electrolyte at a temperature of between 55 and 80° C. (degrees Celsius), but particularly preferably between 60° and 75° C. The deposition rate here is between 0.2 and 0.6 μm (micrometers) per minute, but preferably between 0.3 and 0.4 μm per minute.

The electrolytic deposition of the gold alloy layer (method step d) is advantageously carried out in an aqueous gold bath having the composition 4-6 g/L (grams per liter) gold, 50-60 g/L copper, 0.5-1.0 g/L indium, 22-30 g/L potassium cyanide at pH value 9.5-11.

Very good wear and abrasion resistances arise when the layer thickness is between 0.05 μm and 3 μm, preferably between 0.1 μm and 1.0 μm.

The substrate is preferably only partially coated with a gold alloy. A partial coating can be realized easily by the coating method described above. This saves material. A partial coating is generally realized in such a way that at least the surface regions which form what is termed the contact face are coated.

As already outlined above, electrical contact elements, such as for example contact pins or contact springs, can be protected effectively from abrasion or wear in the electrical industry by the hard gold coatings according to the invention. The differences in the coating can be quantified by the plug cycles. It is thus possible to avoid disruptions to function during the testing of electronic components. The selection of a hard gold coating can in this respect also ensure a good electrical contact.

The electrical conductivity can be adjusted by the proportion of gold in the top layer of the contact element. The conductivity of the coating can be optimized for the respective use. A particularly broad field of application is provided if the gold content is preferably between 50% and 98%, but particularly preferably between 65% and 80%.

A contact element of this type has a contact resistance of between 0.6 and 0.75 mΩ (milliohm).

1. A method for producing an electrical contact element, the base of the contact element being formed by a metallic substrate which undergoes the following method steps in the listed order:
a. cold and/or hot and/or electrolytic degreasing of the substrate,
b. activation of the surface of the substrate
i. in a nickel strike bath or
ii. in a fluoride-containing activation solution or
iii. in a fluoride-free activation solution,
c. galvanic deposition of an intermediate layer,
i. the intermediate layer applied being a galvanically deposited nickel layer or
ii. a nickel alloy layer or
iii. a copper alloy layer, and
d. electrolytic deposition of a gold alloy layer in a continuous and/or pulsed current method, in which the current density is between 0.3 and 0.6 A/dm².

2. The method for producing an electrical contact element as claimed in claim 1, wherein the deposition of the gold alloy layer is carried out in the presence of an electrolyte which, apart from gold, also comprises at least one further component selected from the group consisting of copper and/or nickel and/or cobalt and/or silver and/or platinum and/or palladium and/or indium and/or rhodium and/or iridium and/or ruthenium and/or boron and/or carbon and/or silicon and/or phosphorus and/or arsenic and/or iron and/or zinc.

3. The method for producing an electrical contact element as claimed in claim 1, wherein the elements gold and copper have a proportion of at least 90% in the gold alloy layer.

4. The method for producing an electrical contact element as claimed in claim 1, wherein the gold alloy comprises 50 to 98% by weight gold, 0.5 to 40% by weight copper and 0 to 20% of further alloying constituents.

5. The method for producing an electrical contact element as claimed in claim 1, wherein the gold alloy layer deposition step is carried out in an aqueous gold bath having the composition 4-6 g/L gold, 50-60 g/L copper, 0.5-1.0 g/L indium, 22-30 g/L potassium cyanide at pH value 9.5-11.

6. An electrical contact element which is produced by the method as claimed in claim 1.

7. The electrical contact element as claimed in claim 6, wherein
the substrate is formed of copper or a copper alloy, or steel.

8. The electrical contact element as claimed in claim 6, wherein the layer thickness of the gold alloy layer is between 0.05 μm and 3 μm, preferably between 0.1 μm and 1.0 μm.

9. The electrical contact element as claimed in claim 6, wherein
the gold alloy layer has a hardness of between 250 and 450 HV, preferably of 300 to 400 HV.

10. The electrical contact element as claimed in claim 6, wherein
the substrate is only merely partially provided with a gold alloy layer.

11. The electrical contact element as claimed in claim 6, wherein characterized in that
the contact resistance of the contact element is between 0.6 and 0.75 mΩ.

12. The electrical contact element as claimed in claim 7, wherein the layer thickness of the gold alloy layer is between 0.05 μm and 3 μm, preferably between 0.1 μm and 1.0 μm.

13. The electrical contact element as claimed in claim 7, wherein the gold alloy layer has a hardness of between 250 and 450 HV, preferably of 300 to 400 HV.

14. The electrical contact element as claimed in claim 7, wherein the substrate is only partially provided with a gold alloy layer.

15. The electrical contact element as claimed in claim 7, wherein the contact resistance of the contact element is between 0.6 and 0.75 mΩ.

16. The electrical contact element as claimed in claim 8, wherein the gold alloy layer has a hardness of between 250 and 450 HV, preferably of 300 to 400 HV.

17. The electrical contact element as claimed in claim 8, wherein the substrate is only partially provided with a gold alloy layer.

18. The electrical contact element as claimed in claim 8, wherein the contact resistance of the contact element is between 0.6 and 0.75 mΩ.

19. The electrical contact element as claimed in claim 9, wherein the substrate is only partially provided with a gold alloy layer.

20. The electrical contact element as claimed in claim 9, wherein the contact resistance of the contact element is between 0.6 and 0.75 mΩ.
